(19) United States
(12) Patent Application Publication
(10) Pub. No.: US 2025/0246766 A1
(43) Pub. Date: Jul. 31, 2025

(54) BATTERY HOUSING BODY AND BATTERY PACK

(71) Applicant: Yazaki Corporation, Tokyo (JP)

(72) Inventors: Sadaharu OKUDA, Makinohara-shi (JP); Hajime KATO, Makinohara-shi (JP); Mariko NAKAGAWA, Makinoharo-shi (JP); Masato TANAKA, Makinohara-shi (JP)

(73) Assignee: Yazaki Corporation, Tokyo (JP)

(21) Appl. No.: 19/028,134

(22) Filed: Jan. 17, 2025

(30) Foreign Application Priority Data
Jan. 31, 2024 (JP) 2024-012467

(51) Int. Cl. H01M 50/507; H01M 50/298; H01M 50/503; H01M 50/569

(52) U.S. Cl. CPC H01M 50/507; H01M 50/298; H01M 50/503; H01M 50/569

(57) ABSTRACT

A battery housing body includes a casing capable of housing a plurality of battery cells, with a pair of cell terminals facing a mounting surface, and a first connection bus bar including a first extending portion, a first spring continuously connected at a first side of the first extending portion, and a second spring continuously connected at a second side of the first extending portion. The plurality of battery cells includes a first battery cell and a second battery cell, the first spring is connectable to a cell terminal on a first side in a separating direction out of a pair of cell terminals of the first battery cell, and the second spring is connectable to a cell terminal on a first side in the separating direction out of a pair of cell terminals of the second battery cell.

### BACKGROUND OF THE INVENTION

### Field of the Invention

An embodiment of the present invention relates to a battery housing body and a battery pack.

Priority is claimed on Japanese Patent Application No. 2024-012467, filed in Japan on Jan. 31, 2024, the content of which is incorporated herein by reference.

### Description of Related Art

It is widely known that a plurality of battery cells as a power supply source is used in a device. For example, Japanese Unexamined Patent Application, First Publication No. 2019-149227 discloses that a secondary battery module including a plurality of battery cells is used in an electric vehicle.

### SUMMARY OF THE INVENTION

In the secondary battery module disclosed in Japanese Unexamined Patent Application, First Publication No. 2019-149227, cell terminals of a plurality of battery cells, the cell terminals inserted into terminal insertion holes provided in a bus bar case, are connected by a bus bar. However, in the configuration of the secondary battery module disclosed in Japanese Unexamined Patent Application, First Publication No. 2019-149227, the number of parts for connecting the cell terminals of the plurality of battery cells and the bus bar might increase.

One embodiment of the present invention provides a battery housing body and a battery pack capable of reducing the number of parts.

A battery housing body according to one embodiment of the present invention includes a casing including a mounting surface, the casing capable of housing a plurality of battery cells each including a pair of cell terminals separated from each other in a separating direction, with the pair of cell terminals facing the mounting surface, and a first connection bus bar including a first extending portion extending in an extending direction along the mounting surface, a first spring continuously connected to the first extending portion on a first side in the extending direction of the first extending portion, and a second spring continuously connected to the first extending portion on a second side in the extending direction of the first extending portion, in which the plurality of battery cells includes a first battery cell and a second battery cell, the first spring is connectable to a cell terminal on a first side in the separating direction out of the pair of cell terminals of the first battery cell, and the second spring is connectable to a cell terminal on a first side in the separating direction out of the pair of cell terminals of the second battery cell.

A battery housing body according to one embodiment of the present invention includes a casing including a mounting surface, the casing capable of housing a plurality of battery cells each including a pair of cell terminals, with at least one cell terminal of the pair of cell terminals facing the mounting surface, and a first connection bus bar including a first extending portion extending in an extending direction along the mounting surface, a first spring continuously connected to the first extending portion on a first side in the extending direction of the first extending portion, and a second spring continuously connected to the first extending portion on a second side in the extending direction of the first extending portion, in which the plurality of battery cells includes a first battery cell and a second battery cell, the first spring is connectable to the one cell terminal out of the pair of cell terminals of the first battery cell, and the second spring is connectable to the one cell terminal out of the pair of cell terminals of the second battery cell.

A battery housing body and a battery pack according to one embodiment of the present invention can reduce the number of parts.

### BRIEF DESCRIPTION OF THE DRAWINGS

FIG. 1 is a front view of a battery pack according to an embodiment.

FIG. 2 is a plane view of the battery pack according to the embodiment.

FIG. 3 is a cross-sectional view taken along line III-III of FIG. 2.

FIG. 4 is a plane view of a battery housing body according to the embodiment.

FIG. 5 is a cross-sectional view taken along line V-V of FIG. 2.

FIG. 6 is a perspective view of each connection bus bar according to the embodiment.

FIG. 7 is a cross-sectional view taken along line VII-VII of FIG. 2.

FIG. 8 is a system diagram of a wiring module according to the embodiment.

FIG. 9 is a cross-sectional view of the battery pack before a cover is attached according to the embodiment taken along line V-V in FIG. 2.

FIG. 10 is a cross-sectional view of a battery pack according to a first modification of the embodiment taken along line III-III of FIG. 2.

FIG. 11 is a system diagram of a wiring module according to a second modification of the embodiment.

### DETAILED DESCRIPTION OF THE INVENTION

### Embodiment

Hereinafter, a battery housing body and a battery pack of the present embodiment will be described with reference to the drawings.

### (Configuration of Battery Pack)

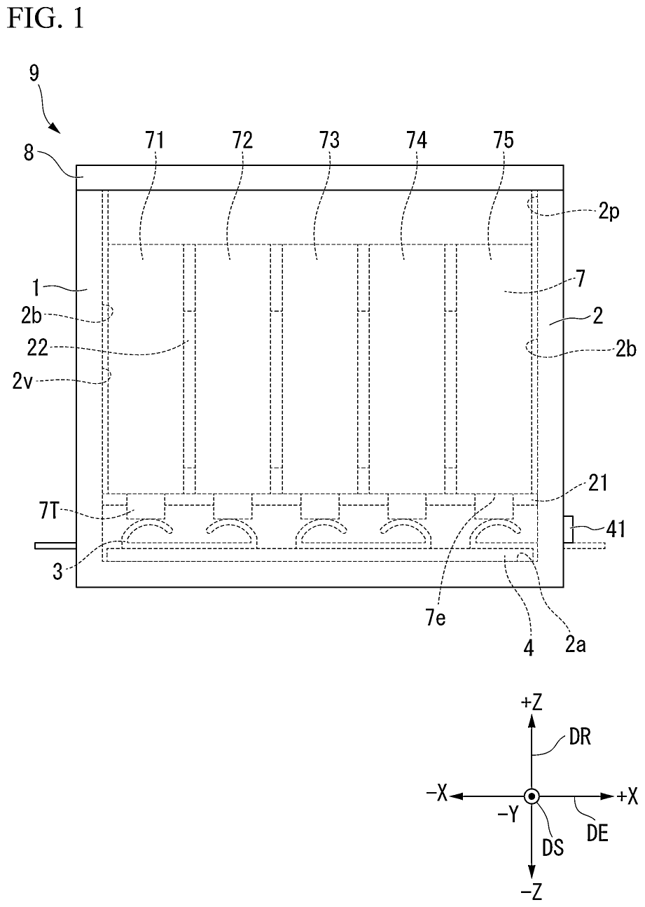

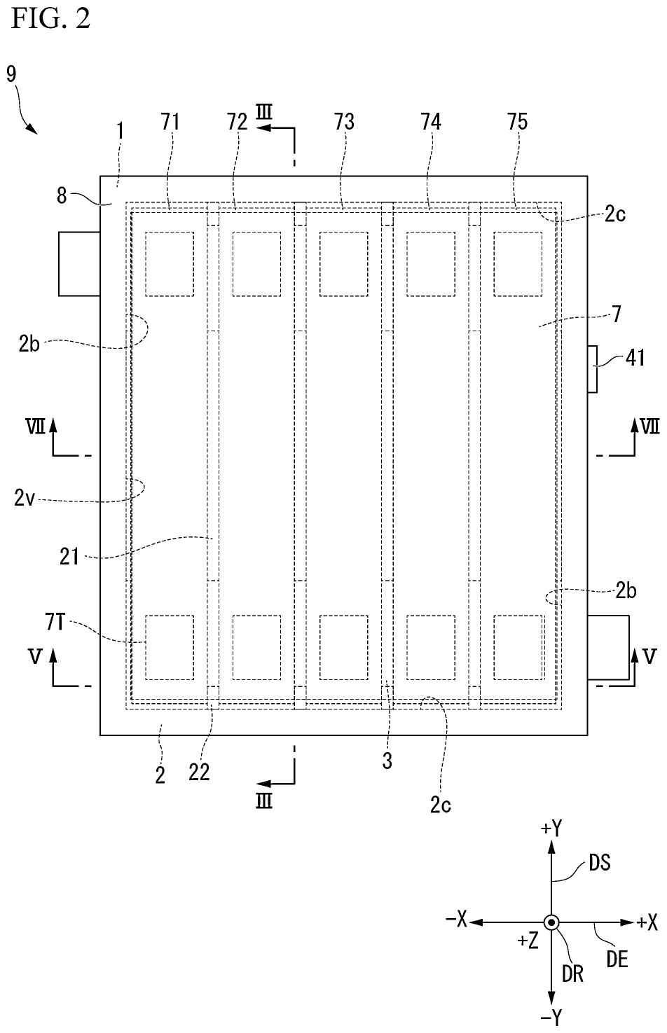

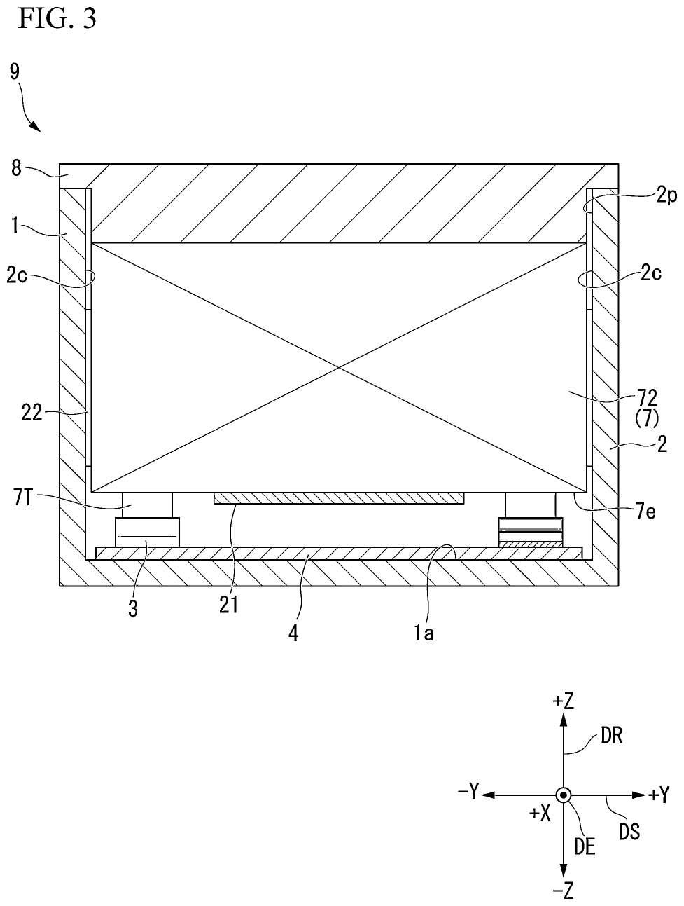

As illustrated in FIGS. 1 to 3, a battery pack 9 of the present embodiment includes a battery housing body 1, a plurality of battery cells 7, and a cover 8. The battery pack 9 is unitized by closing the battery housing body 1 in which the plurality of battery cells 7 is housed with the cover 8. For example, the battery pack 9 may be mounted on a mobility unit such as an electric vehicle.

### (Configuration of Battery Cell)

The plurality of battery cells 7 is housed in the battery housing body 1. The plurality of battery cells 7 is attachable to and detachable from the battery housing body 1. The plurality of battery cells 7 is arranged in one direction. Each battery cell 7 has a rectangular parallelepiped shape. Each battery cell 7 includes an electrode surface 7e.

Hereinafter, a direction in which the plurality of battery cells 7 is arranged is referred to as an X direction. A direction in which the plurality of battery cells 7 can be attached to and detached from the battery housing body 1 is defined as a Z direction. A direction intersecting a ZX plane is defined as a Y direction. The X direction is also referred to as an extending direction DE. The Y direction is also referred to as a separating direction DS. The Z direction is also referred to as an attaching/detaching direction DR. One direction in the X direction is defined as a +X direction, and the other direction in the X direction is defined as a −X direction. One direction in the Y direction is defined as a +Y direction, and the other direction in the Y direction is defined as a −Y direction. One direction in the Z direction is defined as a +Z direction, and the other direction in the Z direction is defined as a −Z direction.

For example, the X direction, the Y direction, and the Z direction may be directions orthogonal to one another. For example, the electrode surface 7e may be a surface along an XY plane. For example, an inserting direction of the plurality of battery cells 7 into the battery housing body 1 may be the −Z direction. For example, a direction in which the electrode surface 7e faces may be the −Z direction. For example, the −Z direction may be a downward direction.

The plurality of battery cells 7 includes a first battery cell 71, a second battery cell 72, a third battery cell 73, a fourth battery cell 74, and a fifth battery cell 75. The first battery cell 71, the second battery cell 72, the third battery cell 73, the fourth battery cell 74, and the fifth battery cell 75 are arranged side by side in this order in the +X direction.

Each battery cell 7 includes a pair of cell terminals 7T. The pair of cell terminals 7T are separated from each other in the separating direction DS. Each cell terminal 7T protrudes from the electrode surface 7e in the −Z direction.

One of the pair of cell terminals 7T is a positive electrode, and the other is a negative electrode. For example, the plurality of battery cells 7 may be arranged in such a manner that the positive electrode and the negative electrode of the battery cells 7 adjacent to each other in the X direction are opposite to each other.

Specifically, regarding the first battery cell 71, the third battery cell 73, and the fifth battery cell 75 out of the plurality of battery cells 7, each pair of cell terminals 7T may include the cell terminal 7T of the positive electrode on a −Y direction side and the cell terminal 7T of the negative electrode on a +Y direction side.

In contrast, regarding the second battery cell 72 and the fourth battery cell 74 out of the plurality of battery cells 7, each pair of cell terminals 7T may include the cell terminal 7T of the negative electrode on the −Y direction side and the cell terminal 7T of the positive electrode on the +Y direction side.

### (Configuration of Battery Housing Body)

The battery housing body 1 is a device for collectively housing the plurality of battery cells 7 and externally outputting a voltage from the plurality of battery cells 7. The battery housing body 1 includes a casing 2, a plurality of bus bars 3, and a wiring module 4.

### (Configuration of Casing)

The casing 2 can house the plurality of battery cells 7 with the pair of cell terminals 7T facing a mounting surface 2a. The casing 2 has a rectangular parallelepiped box shape opened on a +Z direction side. The casing 2 is made of an insulator material such as plastic or a metal material such as aluminum.

The casing 2 includes an opening 2p on the +Z direction side. The casing 2 includes, on an inner side thereof, the mounting surface 2a facing in the +Z direction, a pair of first peripheral side surfaces 2b facing each other in the X direction, and a pair of second peripheral side surfaces 2c facing each other in the Y direction. The casing 2 includes a housing space 2v for housing the plurality of battery cells 7 therein. The housing space 2v is defined by the mounting surface 2a, the pair of first peripheral side surfaces 2b, and the pair of second peripheral side surfaces 2c. For example, each of the mounting surface 2a, the pair of first peripheral side surfaces 2b, and the pair of second peripheral side surfaces 2c may be a flat surface. For example, the casing 2 may include the mounting surface 2a on an inner bottom.

For example, the casing 2 may include a stopper 21 and a plurality of slits 22 therein.

The stopper 21 is a structure for restricting movement of the battery cells 7 in the −Z direction by coming into contact with the electrode surface 7e of the battery cell 7 housed in the casing 2 from a −Z direction side. The stopper 21 is a plate extending in the X direction across the plurality of battery cells 7 between the pair of cell terminals 7T. Both ends extending in the X direction of the stopper 21 are fixed to the pair of first peripheral side surfaces 2b at positions in the Z direction at which the electrode surface 7e should be restricted.

The plurality of slits 22 restricts a position of each battery cell 7 in the X direction in such a manner that the battery cells 7 adjacent to each other in the X direction are arranged with a gap therebetween. The plurality of slits 22 is provided on both of the pair of second peripheral side surfaces 2c. Each slit 22 protrudes in the Y direction from the second peripheral side surface 2c. Each slit 22 extends in the Z direction. Each slit 22 protrudes so as to be fitted between the battery cells 7 adjacent to each other in the X direction.

### (Configuration of Bus Bar)

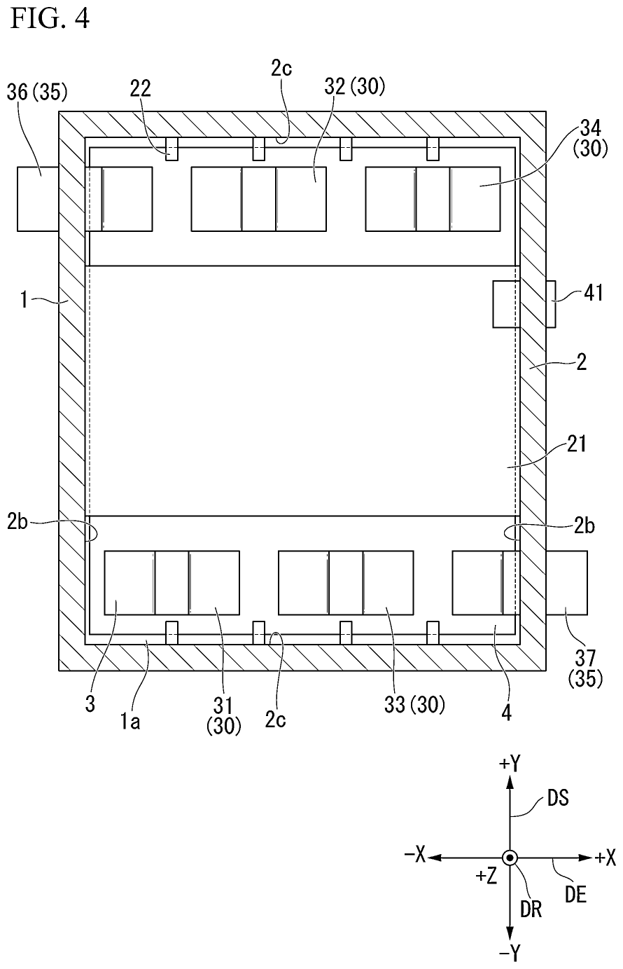

As illustrated in FIG. 4, the plurality of bus bars 3 is arranged along the mounting surface 2a. In the present embodiment, the plurality of bus bars 3 is placed on the wiring module 4. The plurality of bus bars 3 is integrated with the wiring module 4. The plurality of bus bars 3 is formed of a conductive material such as copper or aluminum.

The plurality of bus bars 3 includes a plurality of connection bus bars 30 and a pair of output bus bars 35. The plurality of connection bus bars 30 includes a first connection bus bar 31, a second connection bus bar 32, a third connection bus bar 33, and a fourth connection bus bar 34. The pair of output bus bars 35 include a first output bus bar 36 and a second output bus bar 37.

When viewed in the Z direction, the first connection bus bar 31, the third connection bus bar 33, and the second output bus bar 37 are arranged in this order in the +X direction on the −Y direction side with respect to the stopper 21. When viewed in the Z direction, the first output bus bar 36, the second connection bus bar 32, and the fourth connection bus bar 34 are arranged in this order in the +X direction on the +Y direction side with respect to the stopper 21.

When viewed in the Y direction, the first connection bus bar 31 out of the plurality of connection bus bars 30 is located on the most −X direction side. When viewed in the Y direction, the first connection bus bar 31 is located between the first output bus bar 36 and the second connection bus bar 32. When viewed in the Y direction, the second connection bus bar 32 is located between the first connection bus bar 31 and the third connection bus bar 33. When viewed in the Y direction, the third connection bus bar 33 is located between the second connection bus bar 32 and the fourth connection bus bar 34. When viewed in the Y direction, the fourth connection bus bar 34 out of the plurality of connection bus bars 30 is located on the most +X direction side. When viewed in the Y direction, the fourth connection bus bar 34 is located between the third connection bus bar 33 and the second output bus bar 37.

### (First Connection Bus Bar)

As illustrated in FIG. 5, the first connection bus bar 31 includes a first extending portion 311, a first spring 312, and a second spring 313.

The first extending portion 311 extends in the extending direction DE along the mounting surface 2a. For example, the first extending portion 311 may have a plate shape extending with a constant width and a constant thickness in the X direction.

The first spring 312 is continuously connected to the first extending portion 311 on the −X direction side of the first extending portion 311. The first spring 312 can be connected to the cell terminal 7T on the −Y direction side out of the pair of cell terminals 7T of the first battery cell 71. For example, the first spring 312 includes a first leaf spring 314. The first leaf spring 314 has a shape bent and extending in the +X direction from the first extending portion 311, a rounded shape when viewed in the Y direction.

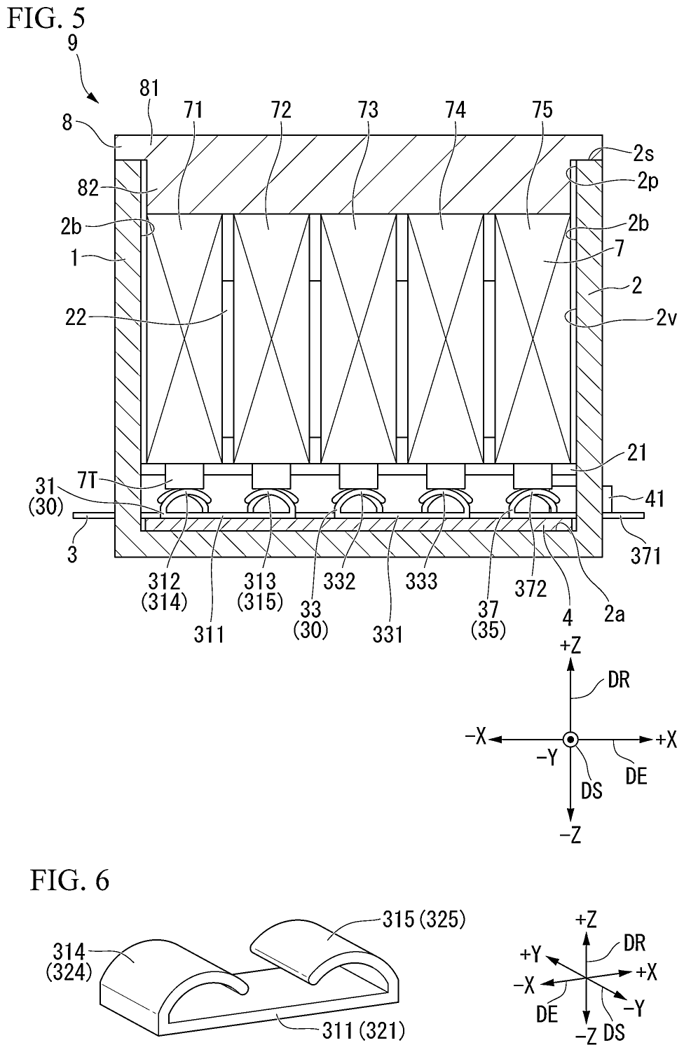

Specifically, the first leaf spring 314 extends so as to rise in the +Z direction from a portion to which the first extending portion 311 extends when viewed in the Y direction. Moreover, when viewed in the Y direction, the first leaf spring 314 has a shape bent at an obtuse angle in a direction between the +Z direction and the +X direction from a portion to which this extends in the +Z direction and extending while gradually bending in the +X direction from a portion at which this bends. As illustrated in FIG. 6, for example, the first leaf spring 314 may extend continuously from the first extending portion 311 with a width and a thickness of a plate shape of the first extending portion 311.

The second spring 313 is continuously connected to the first extending portion 311 on the +X direction side of the first extending portion 311. The second spring 313 can be connected to the cell terminal 7T on the −Y direction side out of the pair of cell terminals 7T of the second battery cell 72. For example, the second spring 313 includes a second leaf spring 315. The second leaf spring 315 has a shape bent and extending in the −X direction from the first extending portion 311, a rounded shape when viewed in the Y direction.

Specifically, the second leaf spring 315 extends so as to rise in the +Z direction from a portion to which the first extending portion 311 extends when viewed in the Y direction. Moreover, when viewed in the Y direction, the fourth leaf spring 325 has a shape bent at an obtuse angle in a direction between the +Z direction and the −X direction from a portion to which this extends in the +Z direction and extending while gradually bending in the −X direction from a portion at which this bends. As illustrated in FIG. 6, for example, the second leaf spring 315 may extend continuously from the first extending portion 311 with a width and a thickness of a plate shape of the first extending portion 311.

### (Third Connection Bus Bar)

The third connection bus bar 33 includes a third extending portion 331, a fifth spring 332, and a sixth spring 333. The fifth spring 332 is continuously connected to the third extending portion 331 on the −X direction side of the third extending portion 331. The fifth spring 332 can be connected to the cell terminal 7T on the −Y direction side out of the pair of cell terminals 7T of the third battery cell 73. The sixth spring 333 is continuously connected to the third extending portion 331 on the +X direction side of the third extending portion 331. The sixth spring 333 can be connected to the cell terminal 7T on the −Y direction side out of the pair of cell terminals 7T of the fourth battery cell 74. In other respects, the third extending portion 331, the fifth spring 332, and the sixth spring 333 may have configurations and structures similar to those of the first extending portion 311, the first spring 312, and the second spring 313, respectively.

### (Second Output Bus Bar)

The second output bus bar 37 includes a sixth extending portion 371 and a tenth spring 372. The sixth extending portion 371 penetrates the casing 2 and protrudes from the casing 2 in the +X direction. The tenth spring 372 is continuously connected to the sixth extending portion 371 on the −X direction side of the sixth extending portion 371. The tenth spring 372 can be connected to the cell terminal 7T on the −Y direction side out of the pair of cell terminals 7T of the fifth battery cell 75. In other respects, the sixth extending portion 371 and the tenth spring 372 may have configurations and structures similar to those of the first extending portion 311 and the first spring 312, respectively.

### (Second Connection Bus Bar)

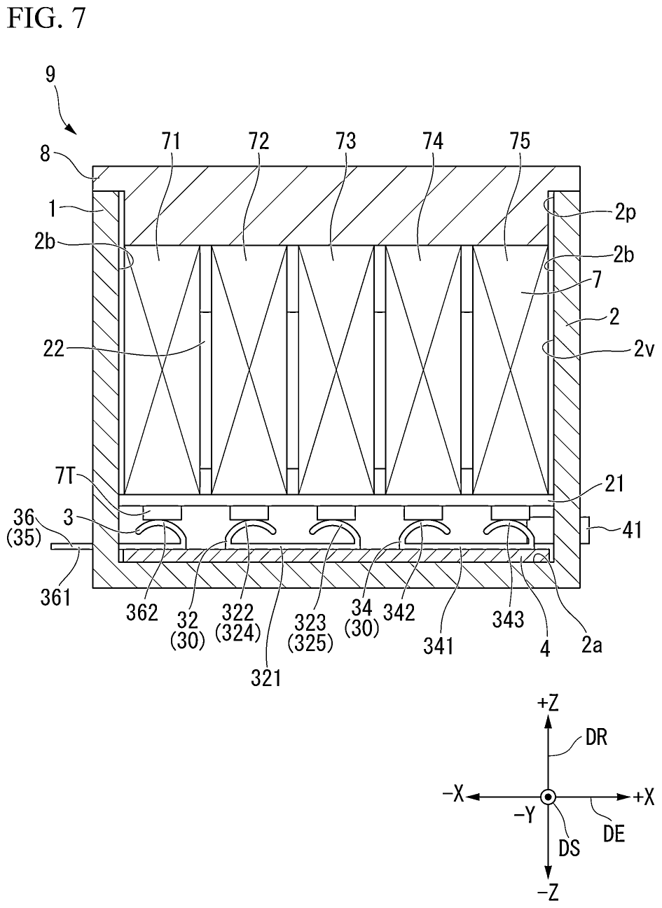

As illustrated in FIG. 7, the second connection bus bar 32 includes a second extending portion 321, a third spring 322, and a fourth spring 323.

The second extending portion 321 extends in the extending direction DE along the mounting surface 2a. For example, the second extending portion 321 may have a plate shape extending with a constant width and a constant thickness in the X direction.

The third spring 322 is continuously connected to the second extending portion 321 on the −X direction side of the second extending portion 321. The third spring 322 can be connected to the cell terminal 7T on the +Y direction side out of the pair of cell terminals 7T of the second battery cell 72. For example, the third spring 322 includes a third leaf spring 324. The third leaf spring 324 has a shape bent and extending in the +X direction from the second extending portion 321, a rounded shape when viewed in the Y direction.

Specifically, the third leaf spring 324 extends so as to rise in the +Z direction from a portion to which the second extending portion 321 extends when viewed in the Y direction. Moreover, the third leaf spring 324 has a shape bent at an obtuse angle in a direction between the +Z direction and the +X direction from a portion to which this extends in the +Z direction and extending while gradually bending in the +X direction from a portion at which this bends when viewed in the Y direction. As illustrated in FIG. 6, for example, the third leaf spring 324 may extend continuously from the second extending portion 321 with a width and a thickness of a plate shape of the second extending portion 321.

The fourth spring 323 is continuously connected to the second extending portion 321 on the +X direction side of the second extending portion 321. The fourth spring 323 can be connected to the cell terminal 7T on the +Y direction side out of the pair of cell terminals 7T of the third battery cell 73. For example, the fourth spring 323 includes a fourth leaf spring 325. The fourth leaf spring 325 has a shape bent and extending in the −X direction from the second extending portion 321, a rounded shape when viewed in the Y direction.

Specifically, the fourth leaf spring 325 extends so as to rise in the +Z direction from a portion to which the second extending portion 321 extends when viewed in the Y direction. Moreover, the fourth leaf spring 325 has a shape bent at an obtuse angle in a direction between the +Z direction and the −X direction from a portion to which this extends in the +Z direction and extending while gradually bending in the −X direction from a portion at which this bends when viewed in the Y direction. As illustrated in FIG. 6, for example, the fourth leaf spring 325 may extend continuously from the second extending portion 321 with a width and a thickness of a plate shape of the second extending portion 321.

### (Fourth Connection Bus Bar)

The fourth connection bus bar 34 includes a fourth extending portion 341, a seventh spring 342, and an eighth spring 343. The seventh spring 342 is continuously connected to the fourth extending portion 341 on the −X direction side of the fourth extending portion 341. The seventh spring 342 can be connected to the cell terminal 7T on the +Y direction side out of the pair of cell terminals 7T of the fourth battery cell 74. The eighth spring 343 is continuously connected to the fourth extending portion 341 on the +X direction side of the fourth extending portion 341. The eighth spring 343 can be connected to the cell terminal 7T on the +Y direction side out of the pair of cell terminals 7T of the fifth battery cell 75. In other respects, the fourth extending portion 341, the seventh spring 342, and the eighth spring 343 may have configurations and structures similar to those of the second extending portion 321, the third spring 322, and the fourth spring 323, respectively.

### (First Output Bus Bar)

The first output bus bar 36 includes a fifth extending portion 361 and a ninth spring 362. The fifth extending portion 361 penetrates the casing 2 and protrudes from the casing 2 in the −X direction. The ninth spring 362 is continuously connected to the sixth extending portion 371 on the +X direction side of the fifth extending portion 361. The ninth spring 362 can be connected to the cell terminal 7T on the +Y direction side out of the pair of cell terminals 7T of the first battery cell 71. In other respects, the fifth extending portion 361 and the ninth spring 362 may have configurations and structures similar to those of the second extending portion 321 and the fourth spring 323, respectively.

### (Configuration of Wiring Module)

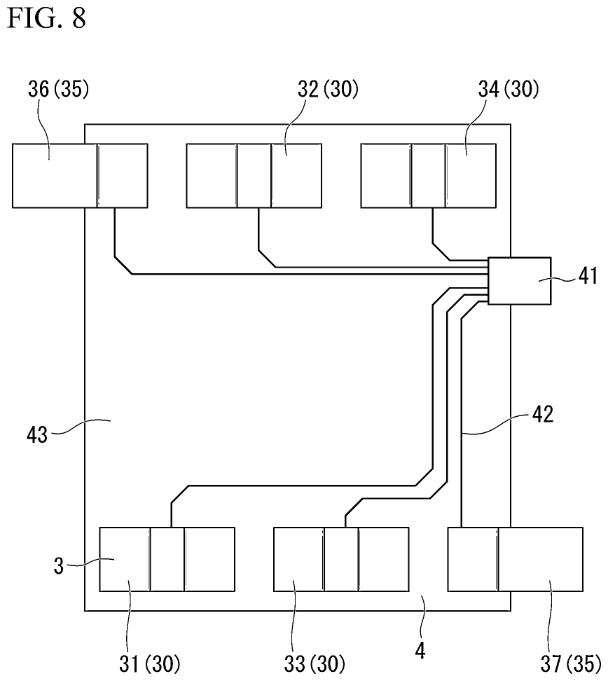

The wiring module 4 is a device for transmitting voltage information of the plurality of battery cells 7 to the outside of the battery pack 9. As illustrated in FIG. 8, the wiring module 4 includes a signal connector 41, a plurality of voltage signal wires 42, and a molding material 43. The molding material 43 is made of an insulator material such as urethane resin, epoxy resin, or silicon resin.

### (Signal Connector)

The signal connector 41 is a terminal for outputting each voltage signal of the plurality of battery cells 7 to the outside of the battery pack 9. For example, the signal connector 41 can output to the outside of the battery pack 9 by penetrating the casing 2 and protruding from the casing 2 in the +X direction.

### (Voltage Signal Wire)

The plurality of voltage signal wires 42 connects each of the plurality of bus bars 3 and the signal connector 41. The plurality of voltage signal wires 42 is connected to the signal connector 41 in the casing 2. For example, an end of each voltage signal wire 42 on the bus bar 3 side may be joined to the bus bar 3 in which a voltage is to be detected by soldering, welding or the like.

### (Molding Material)

In the molding material 43, a plurality of bus bars 3, the signal connector 41, and the plurality of voltage signal wires 42 are integrated. The molding material 43 has a sheet shape spreading in the XY plane as a whole. The molding material 43 is made of a resin material such as epoxy resin, polyimide resin, or fluorine resin.

For example, the −Z side of the molding material 43 may come into contact with the mounting surface 2a. For example, the molding material 43 may cover an entire circumference of each of the plurality of voltage signal wires 42. For example, the molding material 43 may cover an entire or a part of the extending portion of each bus bar 3 out of the plurality of bus bars 3. For example, the molding material 43 may cover only a portion in the casing 2 of the signal connector 41.

### (Configuration of Cover)

The cover 8 has a configuration for closing the opening 2p of the casing 2 from the +Z direction side. The cover 8 presses each of the plurality of battery cells 7 against the connection bus bar 30 to be connected out of the plurality of connection bus bars 30 while closing the opening 2p. For example, the cover 8 presses the first battery cell 71 and the second battery cell 72 against the first connection bus bar 31 while closing the opening 2p. As illustrated in FIG. 5, the cover 8 includes a flange 81 and a pressing portion 82. The flange 81 comes into contact with an upper surface 2s of the casing 2 around the opening 2p. The pressing portion 82 protrudes from the flange 81 in the −Z direction in the opening 2p so as to be fitted into the opening 2p.

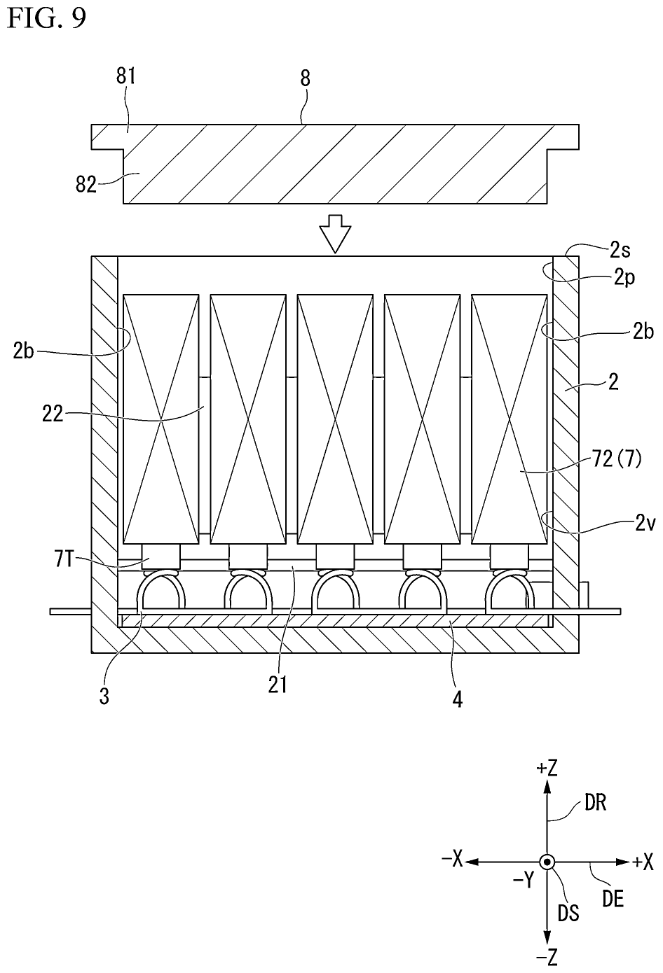

With such a configuration of the cover 8, as illustrated in FIG. 9, the cover 8 can press each of the plurality of battery cells 7 against the bus bar 3 to be connected by the pressing portion 82 while closing the casing 2 by the flange 81. A protruding length of the pressing portion 82 in the −Z direction is a length that can press the plurality of battery cells 7 to a position where a plurality of cell terminals 7T receives a biasing force from each spring of the bus bar 3 to be connected. In contrast, the protruding length of the pressing portion 82 in the −Z direction is shorter than a length that can press the plurality of battery cells 7 to a position where the electrode surface 7e of the plurality of battery cells 7 comes into contact with the stopper 21. The cover 8 is made of an insulator material such as plastic or a metal material such as aluminum.

### (Operation and Effect)

According to the present embodiment, the first spring 312 and the second spring 313 are continuously connected to the first extending portion 311. With the configuration of the first spring 312 and the second spring 313, the first connection bus bar 31 has a configuration integrally including a connector that receives the cell terminal 7T. With this integration, in the battery housing body 1, the first connection bus bar 31 can be directly connected to the first battery cell 71 and the second battery cell 72 housed in the casing 2. That is, the first connection bus bar 31 functions both as a coupling bus bar and as a connection terminal. Therefore, the number of parts of the battery housing body 1 can be reduced.

Similarly, according to the present embodiment, the third spring 322 and the fourth spring 323 are continuously connected to the second extending portion 321. The fifth spring 332 and the sixth spring 333 are continuously connected to the third extending portion 331. The seventh spring 342 and the eighth spring 343 are continuously connected to the fourth extending portion 341. The ninth spring 362 is continuously connected to the fifth extending portion 361. The tenth spring 372 is continuously connected to the sixth extending portion 371. Therefore, the number of parts of the battery housing body 1 can be reduced.

According to the present embodiment, a bent portion of the first connection bus bar 31 can function as a connector that receives the cell terminal 7T. With this structure, the first connection bus bar 31 can be processed from one metal flat plate by sheet metal processing, for example. Therefore, it is easy to process the first connection bus bar 31.

Similarly, according to the present embodiment, a bent portion of the second connection bus bar 32 can function as a connector that receives the cell terminal 7T. A bent portion of the third connection bus bar 33 can function as a connector that receives the cell terminal 7T. A bent portion of the fourth connection bus bar 34 can function as a connector that receives the cell terminal 7T. A bent portion of the first output bus bar 36 can function as a connector that receives the cell terminal 7T. A bent portion of the second output bus bar 37 can function as a connector that receives the cell terminal 7T. Therefore, each of the bus bars which are the second connection bus bar 32, the third connection bus bar 33, the fourth connection bus bar 34, the first output bus bar 36, and the second output bus bar 37 is easily processed.

According to the present embodiment, the first spring 312 can be connected to the cell terminal 7T on the −Y direction side of the first battery cell 71. The second spring 313 can be connected to the cell terminal 7T on the −Y direction side of the second battery cell 72. In addition, the third spring 322 can be connected to the cell terminal 7T on the +Y direction side of the second battery cell 72. The fourth spring 323 can be connected to the cell terminal 7T on the +Y direction side of the third battery cell 73. With the configuration of each spring, the battery housing body 1 can connect the plurality of battery cells 7 in series.

According to the present embodiment, the battery housing body 1 has a structure in which the plurality of connection bus bars 30 is arranged along the mounting surface 2a, and each spring is attached to the plurality of battery cells 7. The structure of the battery housing body 1 reduces work of connecting the plurality of battery cells 7 in the battery housing body 1. Therefore, attachment workability of the battery cell is improved.

According to the present embodiment, the battery housing body 1 has a structure to and from which the plurality of battery cells 7 can be attached and detached. With this structure of the battery housing body 1, the plurality of battery cells 7 can be disassembled from the battery housing body 1 without destroying or deteriorating the cell terminals 7T. Therefore, it is easy to recycle and reuse the battery cell.

According to the present embodiment, in the molding material 43, the plurality of bus bars 3, the signal connector 41, and the plurality of voltage signal wires 42 are integrated. By this molding, the wiring module 4 and the plurality of bus bars 3 can be integrally configured. Therefore, the number of parts of the battery housing body 1 can be reduced.

According to the present embodiment, the stopper 21 can restrict the movement of the battery cell 7 in the −Z direction. This restriction can limit an amount of pressing of the plurality of battery cells 7 against the bus bar 3 by the pressing portion 82. Therefore, it is easy to secure an appropriate contact pressure between the plurality of battery cells 7 and the plurality of bus bars 3.

According to the present embodiment, each slit 22 has a structure extending in the Z direction. Due to the structure of each slit 22, the plurality of battery cells 7 is inserted along each slit 22. Therefore, work of inserting the battery cell is reduced.

According to the present embodiment, each of the plurality of battery cells 7 is pressed against the bus bar 3 to be connected by the cover 8. With this cover 8, the plurality of pressed battery cells 7 can come into contact with the bus bar 3 while receiving the biasing force from each spring of the bus bar 3 to be connected. Therefore, it is easy to secure the contact between the plurality of battery cells 7 and the plurality of bus bars 3.

### (First Modification)

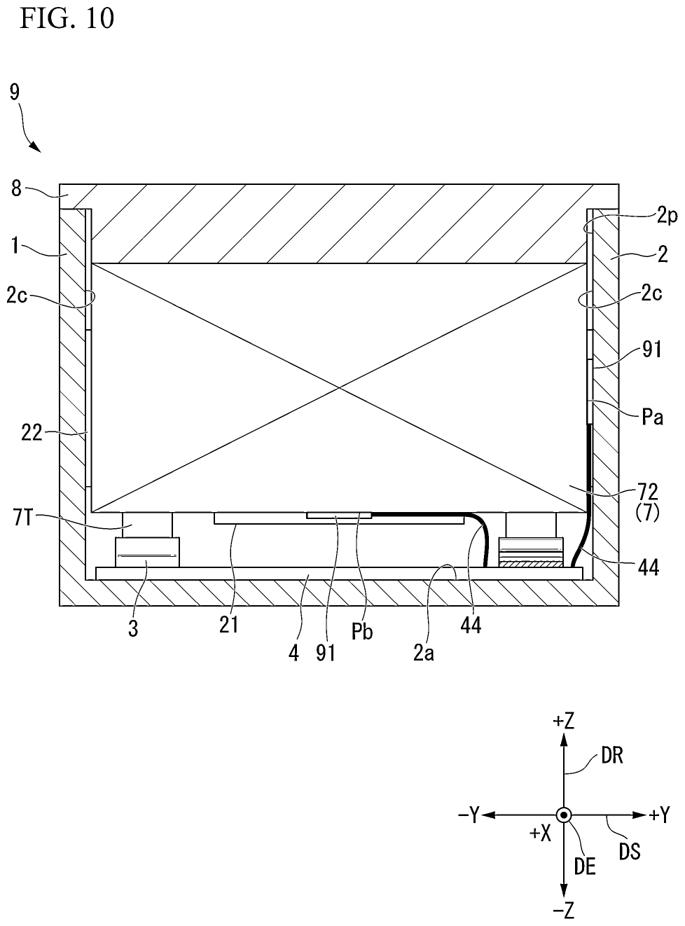

In the present embodiment, a wiring module 4 includes a voltage signal wire 42. However, the wiring module 4 is not limited to the voltage signal wire 42, and can be any wire as long as a battery state of a plurality of battery cells 7 can be output. As a first modification, as illustrated in FIG. 10, the wiring module 4 may include a plurality of temperature signal wires 44.

In the present modification, a battery pack 9 includes a plurality of temperature sensors 91 such as thermistors capable of detecting temperatures of the plurality of battery cells 7. The plurality of temperature signal wires 44 connects each of the temperature sensors 91 and a signal connector 41.

For example, the plurality of temperature sensors 91 may be provided at a side surface position Pa facing a Y direction of the plurality of battery cells 7 and a bottom surface position Pb facing a −Z direction of the plurality of battery cells 7 including electrode surfaces 7e. For example, in the plurality of temperature signal wires 44, a part of a molding material 43 may be cut out, and pattern wiring may be performed on a cutout portion. At the time of the wiring, an end of each temperature signal wire 44 is connected to the temperature sensor 91 by soldering mounting. In contrast, between the temperature sensor 91 and the pattern wiring, each temperature signal wire 44 may be adhered to the side surface position Pa and the bottom surface position Pb of the plurality of battery cells 7 with an adhesive via a heat transfer material.

According to the wiring module 4 of the first modification, the plurality of temperature signal wires 44 and the plurality of bus bars 3 can be integrated while being configured to output the temperature detection signal. Therefore, the number of parts of the battery housing body 1 can be reduced.

### (Second Modification)

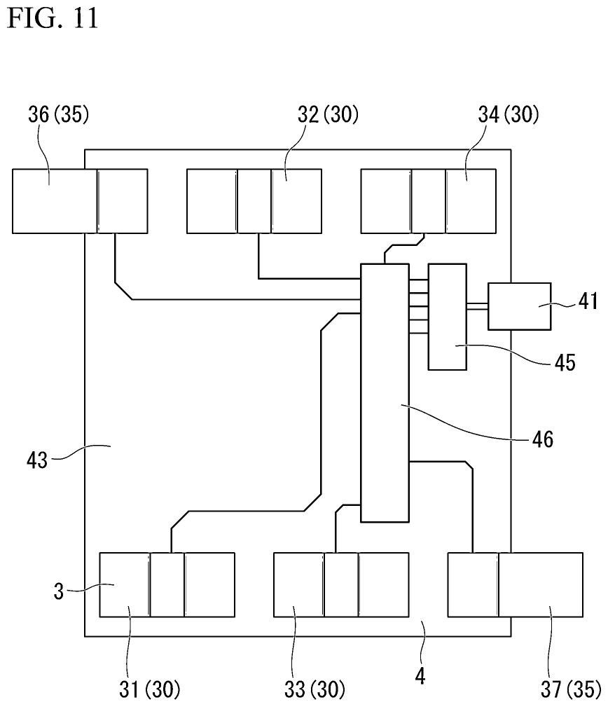

In the present embodiment, a wiring module 4 includes a plurality of voltage signal wires 42. However, it is not limited to the plurality of voltage signal wires 42, and a configuration having a function of using a detected voltage may be further provided. As a second modification, as illustrated in FIG. 11, the wiring module 4 may include a processing circuit 45 and a balance circuit 46 in the middle of the plurality of voltage signal wires 42.

The processing circuit 45 estimates a battery state of the plurality of battery cells 7. The balance circuit 46 smooths a voltage between the plurality of battery cells 7 on the basis of the estimated battery state. A molding material 43 molds a signal connector 41, the plurality of voltage signal wires 42, the processing circuit 45, and the balance circuit 46 integrally in a sheet shape together with a plurality of bus bars 3.

According to the wiring module 4 of the second modification, the plurality of bus bars 3, the processing circuit 45, and the balance circuit 46 can be integrated while being configured to be able to smooth the voltage between the plurality of battery cells 7. Therefore, the number of parts of the battery housing body 1 can be reduced.

### (Other Modifications)

In the present embodiment, each leaf spring of a first leaf spring 314, a second leaf spring 315, a third leaf spring 324, and a fourth leaf spring 325 has a bent and extending shape, a rounded shape when viewed in a Y direction. However, each leaf spring may have any shape as long as the leaf spring has a structure that can be formed of a plate material so as to be integrated with a corresponding extending portion and is bent and extending from the corresponding extending portion. As a modification, each leaf spring may be bent and extending in any shape such as a C shape, a U shape, an L shape, and a V shape from the extending portion when viewed in the Y direction.

In one example of the present embodiment, a battery housing body 1 is configured such that an inserting direction of a plurality of battery cells 7 into a battery housing body 1 is a downward direction. However, the battery housing body 1 may be configured in any manner as long as the battery housing body 1 can house the plurality of battery cells 7 and the plurality of battery cells 7 is attachable to and detachable from the battery housing body 1. As a modification, in the battery housing body 1, an opening 2p may be provided on a lower side, and a mounting surface 2a may be provided on an upper side. As another modification, in the battery housing body 1, the opening 2p may be provided on a first lateral side, and the mounting surface 2a may be provided on a second lateral side.

In the present embodiment, a plurality of bus bars 3 includes, as a plurality of connection bus bars 30, a first connection bus bar 31, a second connection bus bar 32, a third connection bus bar 33, and a fourth connection bus bar 34. However, the plurality of connection bus bars 30 included in the plurality of bus bars 3 may be any number. As a modification, a plurality of bus bars 3 may include only three or less connection bus bars 30. As another modification, the plurality of bus bars 3 may include five or more connection bus bars 30.

In the present embodiment, as illustrated in FIG. 4, the plurality of bus bars 3 is arranged. However, the plurality of bus bars 3 may be arranged in any manner as long as the plurality of battery cells 7 can be connected.

In the present embodiment, the first connection bus bar 31 is connected to a first battery cell 71 as a first battery cell and a second battery cell 72 as a second battery cell, but may be connected to any battery cell. As a modification, the first connection bus bar 31 may be connected to the second battery cell 72 as the first battery cell and a third battery cell 73 as the second battery cell. In addition, in this modification, the second connection bus bar 32 may be connected to the third battery cell 73 as the second battery cell and a fourth battery cell 74 as a third battery cell. As another modification, the first connection bus bar 31 may be connected to the third battery cell 73 as the first battery cell and the fourth battery cell 74 as the second battery cell. In addition, in this modification, the second connection bus bar 32 may be connected to the fourth battery cell 74 as the second battery cell and a fifth battery cell 75 as a third battery cell.

In the present embodiment, the plurality of bus bars 3 is placed on a wiring module 4 to be integrated therewith. However, any configuration may be adopted as long as the number of parts of each bus bar can be reduced. As a modification, it is possible that the plurality of bus bars 3 is not mounted on the wiring module 4 but directly mounted on the mounting surface 2a separately without being integrated.

In the present embodiment, the battery housing body 1 houses a pair of cell terminals 7T of each battery cell 7 so as to face the mounting surface 2a. However, as long as the plurality of connection bus bars 30 can connect the plurality of battery cells, the battery housing body 1 may house any plurality of battery cells. As a modification, the battery housing body 1 may house the battery cell 7 in which one cell terminal 7T out of the pair of cell terminals 7T faces the mounting surface 2a instead of the battery cell 7 in which the pair of cell terminals 7T face the mounting surface 2a. That is, the casing 2 may be capable of housing at least one cell terminal 7T of the pair of cell terminals 7T so as to face the mounting surface 2a. Each spring may be connectable to one cell terminal 7T out of the pair of cell terminals 7T with respect to the plurality of battery cells 7 of the present modification housed as described above.

While preferred embodiments of the invention have been described and illustrated above, it should be understood that these are exemplary of the invention and are not to be considered as limiting. The embodiments can be implemented in various other forms, and various omissions, substitutions, and changes can be made without departing from the gist of the present disclosure. Accordingly, the invention is not to be considered as being limited by the foregoing description, and is only limited by the scope of the appended claims.

### INDUSTRIAL APPLICABILITY

A battery housing body and a battery pack according to the present disclosure can reduce the number of parts.

### BRIEF DESCRIPTION OF THE REFERENCE SYMBOLS

1 Battery housing body
2 Casing
2a Mounting surface
2b First peripheral side surface
2c Second peripheral side surface
2p Opening
2s Upper surface
2v Housing space
3 Bus bar
4 Wiring module
7 Battery cell
7e Electrode surface
7T Cell terminal
8 Cover
9 Battery pack
21 Stopper
22 Slit
30 Connection bus bar
31 First connection bus bar
32 Second connection bus bar
33 Third connection bus bar
34 Fourth connection bus bar
35 Output bus bar
36 First output bus bar
37 Second output bus bar
41 Signal connector
42 Voltage signal wire
43 Molding material
44 Temperature signal wire
45 Processing circuit
46 Balance circuit
71 First battery cell
72 Second battery cell
73 Third battery cell
74 Fourth battery cell
75 Fifth battery cell
81 Flange
82 Pressing portion
91 Temperature sensor
311 First extending portion
312 First spring
313 Second spring
321 Second extending portion
322 Third spring
323 Fourth spring
331 Third extending portion
332 Fifth spring
333 Sixth spring
341 Fourth extending portion
342 Seventh spring
343 Eighth spring
361 Fifth extending portion
362 Ninth spring
371 Sixth extending portion
372 Tenth spring
DE Extending direction
DR Attaching/detaching direction
DS Separating direction
Pa Side surface position
Pb Bottom surface position

What is claimed is:

1. A battery housing body comprising:
a casing including a mounting surface, the casing capable of housing a plurality of battery cells each including a pair of cell terminals separated from each other in a separating direction, with the pair of cell terminals facing the mounting surface; and
a first connection bus bar including a first extending portion extending in an extending direction along the mounting surface, a first spring continuously connected to the first extending portion on a first side in the extending direction of the first extending portion, and a second spring continuously connected to the first extending portion on a second side in the extending direction of the first extending portion, wherein
the plurality of battery cells includes a first battery cell and a second battery cell,
the first spring is connectable to a cell terminal on a first side in the separating direction out of the pair of cell terminals of the first battery cell, and
the second spring is connectable to a cell terminal on a first side in the separating direction out of the pair of cell terminals of the second battery cell.

2. The battery housing body according to claim 1, wherein
the first spring includes a first leaf spring having a shape bent and extending from the first extending portion to the second side in the extending direction, and
the second spring includes a second leaf spring having a shape bent and extending from the first extending portion to the first side in the extending direction.

3. The battery housing body according to claim 1, wherein
the plurality of battery cells further includes a third battery cell,
the first battery cell, the second battery cell, and the third battery cell are arranged side by side in order in the extending direction,
a second connection bus bar including a second extending portion extending in the extending direction along the mounting surface, a third spring continuously connected to the second extending portion on the first side in the extending direction of the second extending portion, and a fourth spring continuously connected to the second extending portion on the second side in the extending direction of the second extending portion is further included,
the third spring is connectable to a cell terminal on the second side in the separating direction out of the pair of cell terminals of the second battery cell, and
the fourth spring portion is connectable to a cell terminal on the second side in the separating direction out of the pair of cell terminals of the third battery cell.

4. The battery housing body according to claim 3, further comprising:
a wiring module including a signal connector, a plurality of voltage signal wires, and a molding material, the signal connector being capable of outputting a voltage signal of each of the plurality of battery cells, the plurality of voltage signal wires connecting each of the first connection bus bar and the second connection bus bar to the signal connector,
wherein the molding material integrates the first connection bus bar, the second connection bus bar, the signal connector, and the plurality of voltage signal wires.

5. The battery housing body according to claim 4, wherein
the wiring module further includes a temperature signal wire connecting a temperature sensor and the signal connector, the temperature sensor capable of detecting temperatures of the plurality of battery cells.

6. The battery housing body according to claim 4, wherein
the wiring module further includes a processing circuit that estimates a battery state of the plurality of battery cells, and a balance circuit that smooths a voltage between the plurality of battery cells on the basis of the battery state.

7. The battery housing body according to claim 1, wherein
each battery cell includes an electrode surface from which the pair of cell terminals protrude, and
the casing includes a stopper that comes into contact with the electrode surface and restricts movement of the battery cell.

8. A battery pack comprising:
the battery housing body according to claim 1; and
the plurality of battery cells.

9. The battery pack according to claim 8, wherein
the casing includes an opening, and
a cover that presses the first battery cell and the second battery cell against the first connection bus bar while closing the opening is further included.

10. A battery housing body comprising:
a casing including a mounting surface, the casing capable of housing a plurality of battery cells each including a pair of cell terminals, with at least one cell terminal of the pair of cell terminals facing the mounting surface; and
a first connection bus bar including a first extending portion extending in an extending direction along the mounting surface, a first spring continuously connected to the first extending portion on a first side in the extending direction of the first extending portion, and a second spring continuously connected to the first extending portion on a second side in the extending direction of the first extending portion,
wherein the plurality of battery cells includes a first battery cell and a second battery cell,
the first spring is connectable to the one cell terminal out of the pair of cell terminals of the first battery cell, and
the second spring is connectable to the one cell terminal out of the pair of cell terminals of the second battery cell.
